(19) United States
(12) Patent Application Publication
(10) Pub. No.: US 2012/0146921 A1
(43) Pub. Date: Jun. 14, 2012

(54) TOUCH SCREEN PANEL

(76) Inventor: Jung-Mok Park, Yongin-city (KR)

(21) Appl. No.: 13/106,742

(22) Filed: May 12, 2011

(30) Foreign Application Priority Data
Dec. 13, 2010 (KR) 10-2010-0126949

(51) Int. Cl. G06F 3/041

(52) U.S. Cl. 345/173

(57) ABSTRACT

There is provided a touch screen panel. The touch screen panel includes a window substrate including a transmitting region, a frame outside the transmitting region, and a groove formed at the frame, a decoration layer at the groove, a transparent adhesive layer on a surface of a window substrate and top of the decoration layer, a transparent substrate adhered to the window substrate by the transparent adhesive layer, the transparent substrate including a touch inactive region corresponding to the frame and a touch active region corresponding to the transmitting region, and a plurality of conductive sensing patterns on the touch active region of the transparent substrate and position detecting lines on the touch inactive region.

### CROSS-REFERENCE TO RELATED APPLICATION

This application claims priority to and the benefit of Korean Patent Application No. 10-2010-0126949, filed on Dec. 13, 2010, in the Korean Intellectual Property Office, the entire content of which is incorporated herein by reference.

### BACKGROUND

1. Field

Aspects of embodiments according to the present invention relate to a touch screen panel included in an image display device.

2. Description of the Related Art

A touch panel is an input device capable of selecting the indication content displayed on the screen of an image display device by a human hand or an object to input user commands.

Therefore, the touch panel is provided on the front face of the image display device to convert a contact position touched by the human hand or the object into an electrical signal. Therefore, the instruction content selected at the contact position is received as an input signal.

Since the touch panel may replace an additional input device, e.g., a keyboard or a mouse, coupled to the image display device, applications for touch panel are gradually being increased.

When a touch panel (e.g., a touch screen panel) is attached onto the top of the panel of the image display device, the volume of the display device increases so that it becomes less convenient to carry. Therefore, the development of a thin touch screen panel is in progress.

In addition, in the case of a typical touch screen panel, a window substrate is additionally provided on the top surface of the touch screen panel in order to improve the strength of the apparatus and the window substrate is attached onto the top surface of the touch screen panel using a transparent adhesive layer.

However, as described above, when the window substrate and the adhesive layer are additionally provided, the thickness of the touch screen panel is increased so that the touch screen panel is prevented from being made thin.

### SUMMARY

Accordingly, embodiments of the present invention are directed toward a touch screen panel, in which a groove is formed at a frame of a window substrate where a decoration layer is formed to remove a step difference generated when the decoration layer is formed and to reduce the thickness of the touch screen panel provided on the window substrate.

In order to achieve the foregoing and/or other aspects of the present invention, according to one embodiment, a touch screen panel includes a window substrate including a transmitting region, a frame outside of the transmitting region, and a groove at the frame, a decoration layer at the groove, a transparent adhesive layer on a surface of the window substrate and a top of the decoration layer, a transparent substrate adhered to the window substrate by the transparent adhesive layer, the transparent substrate including a touch inactive region corresponding to the frame and a touch active region corresponding to the transmitting region, and a plurality of conductive sensing patterns on the touch active region of the transparent substrate and position detecting lines on the touch inactive region.

The touch screen panel may further include a protective layer on the transparent substrate and top of the conductive sensing patterns and the position detecting lines.

The sensing patterns may include first sensing cells coupled to one another by column lines in a first direction, first coupling lines for coupling adjacent ones of the first sensing cells, second sensing cells coupled to one another by row lines in a second direction, and second coupling lines for coupling adjacent ones of the second sensing cells.

Insulating layers may be interposed at crossing regions of the first coupling lines and the second coupling lines.

The first sensing cells and the second sensing cells may include a transparent conductive material.

According to another embodiment of the present invention, a touch screen panel includes a window substrate including a transmitting region, a frame outside the transmitting region, and a groove at the frame, a decoration layer at the groove, a buffer layer on a surface of the window substrate and a top of the decoration layer, and conductive sensing patterns on a part of the buffer layer that overlaps the transmitting region and position detecting lines on a part of the buffer layer that overlaps the frame.

As described above, according to embodiments of the present invention, the groove is formed in the frame of the window substrate where the decoration layer is formed to remove the step difference generated when the decoration layer is formed and to reduce the thickness of the touch screen panel provided on the window substrate.

In addition, the sensing patterns for realizing the touch screen panel are formed on the window substrate so that the thickness of the touch screen panel may be minimized or reduced.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view schematically illustrating an example of a touch screen panel;

FIG. 2 is an enlarged view of a main part illustrating an example of a sensing pattern of FIG. 1;

FIG. 3 is a cross sectional view illustrating a touch screen panel according to an embodiment of the present invention; and

FIG. 4 is a cross sectional view illustrating a touch screen panel according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” or “coupled to” another element, it can be directly connected to the element or be indirectly connected to the element with one or more intervening elements interposed therebetween. Hereinafter, like reference numerals refer to like elements.

Hereinafter, the embodiments of the present invention will be described in detail with reference to the accompanying drawings.

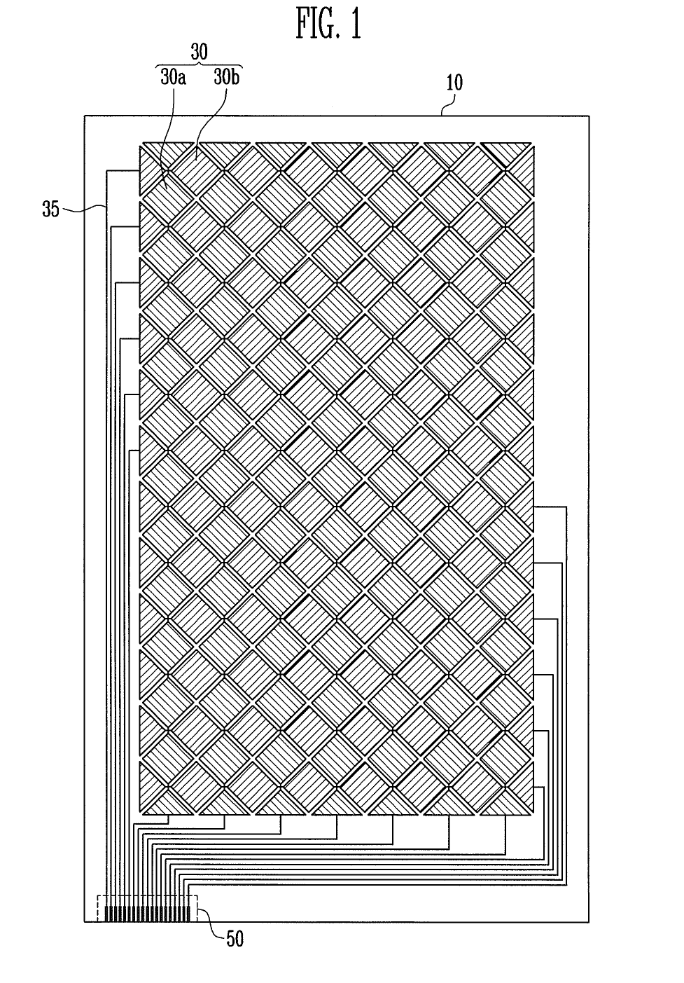

FIG. 1 is a plan view schematically illustrating an example of a touch screen panel. FIG. 2 is an enlarged view of a main part illustrating an example of the sensing pattern of FIG. 1.

Referring to FIGS. 1 and 2, the touch screen panel according to an embodiment of the present invention includes a transparent substrate 10, a plurality of conductive sensing pattern 30 formed on the transparent substrate 10, and position detecting lines 35 for coupling the sensing patterns 30 to an external driving circuit through a pad unit 50.

The sensing patterns 30 are formed on a surface of a touch active region of the transparent substrate 10 using a transparent electrode material such as indium tin oxide (ITO) and include first sensing cells 30a coupled in a first direction and second sensing cells 30b coupled in a second direction.

The first sensing cells 30a are formed to be coupled in the first direction, for example, in a column line direction to be coupled to the position detecting lines 35 in units of column lines (i.e., column by column).

The second sensing cells 30b are formed to be coupled in a second direction different from the first direction, for example, in a row line direction between the first sensing cells 30a to be insulated from the first sensing cells 30a and are coupled to the position detecting lines 35 in units of row lines (i.e., row by row).

The first sensing cells 30a and the second sensing cells 30b may be formed at the same layer. In this case, the first sensing cells 30a and the second sensing cells 30b may be coupled in the first direction and the second direction by first coupling lines 30a1 (shown in FIG. 2) and second coupling lines 30b1 (shown in FIG. 2) insulated from each other with an insulating layer interposed therebetween or may be positioned at different layers with the insulating layer interposed therebetween.

In more detail, referring to the embodiment illustrated in FIG. 2, the sensing patterns 30 include the first sensing cells 30a coupled in the first direction, the first coupling lines 30a1 for coupling the first sensing cells 30a in the first direction, the second sensing cells 30b coupled in the second direction, and the second coupling lines 30b1 for coupling the second sensing cells 30b in the second direction.

For convenience sake, in FIG. 2, only a part of the sensing patterns is illustrated. However, the touch screen panel has a structure in which the sensing patterns illustrated in FIG. 2 are repeatedly arranged.

The first sensing cells 30a and the second sensing cells 30b are alternately arranged not to overlap each other, and the first coupling lines 30a1 and the second coupling lines 30b1 cross each other. Here, an insulating layer (not shown) for securing stability may be interposed between the first coupling lines 30a1 and the second coupling lines 30b1.

In one embodiment, the first sensing cells 30a and the second sensing cells 30b are integrally formed with the first coupling lines 30a1 and the second coupling lines 30b1 using the transparent electrode material such as the ITO. In another embodiment, the first sensing cells 30a and the second sensing cells 30b are formed to be separated from the first coupling lines 30a1 and the second coupling lines 30b1 to be electrically coupled to the first coupling lines 30a1 and the second coupling lines 30b1.

For example, the first sensing cells 30a are formed to be integrally patterned with the first coupling lines 30a1 in a column direction, and the second sensing cells 30b are patterned to be independent patterns between the first sensing cells 30a and may be coupled in a row direction by the second coupling lines 30b1 positioned on or under the second sensing cells 30b.

Here, the second coupling lines 30b1 directly contact the second sensing cells 30b on or under the second sensing cells 30b to be electrically coupled to the second sensing cells 30b or may be electrically coupled to the second sensing cells 30b through contact holes.

The second coupling lines 30b1 are formed of a transparent electrode material such as ITO or an opaque low resistant material so that the width of the second coupling lines 30b1 may be controlled to prevent or reduce the visibility of a pattern.

In addition, the position detecting lines 35 are electrically coupled to the first and second sensing cells 30a and 30b in units of column and row lines to couple the sensing patterns 30 to an external driving circuit (not shown) such as a position detecting circuit.

The position detecting lines 35 are arranged in a touch inactive region at the periphery of the touch screen panel to avoid the touch active region in which an image is displayed, and have a large range of choice of a material. In some embodiments, the position detecting lines 35 may be formed of a low resistance material such as Mo, Ag, Ti, Cu, Ti, Mo/Al/Mo other than a transparent electrode material used for forming the sensing cells 30.

When a contact object such as a human hand or a stylus pen contacts the touch screen panel described above as an electrostatic capacitive touch screen panel, a change in electrostatic capacity in accordance with a contact position is transmitted from the sensing patterns 30 to a driving circuit (not shown) via the position detecting lines 35 and the pad unit 50.

Then, the change in the electrostatic capacity is converted into an electric signal by an X and Y input processing circuit (not shown) so that the contact position is determined.

A window substrate (not shown) may be provided on the top surface of the touch screen panel in order to improve the strength of the apparatus. The window substrate may be attached onto the top surface of the touch screen panel using a transparent adhesive layer such as an optically clear adhesive (OCA) or super viewing resin (SVR).

In addition, a decoration layer (not shown) is formed in the frame of the window substrate to correspond to the touch inactive region provided at the periphery of the touch active region.

Here, the decoration layer prevents the position detecting lines formed under the touch inactive region from being visualized. A logo may be inserted into one region of the decoration layer.

However, the decoration layer may be coated on or printed to the frame of the window substrate. In this case, a step difference of no less than 10 μm is generated between the decoration layer and a transmission region corresponding to the touch active region.

The step difference may cause the generation of an air bubble in the step difference region when the transparent adhesive layer is formed on the window.

In a conventional art, in order to solve such a problem, the transparent adhesive layer is formed to be thick to have a thickness of about 100 to 200 μm. As such, the touch screen panel is prevented from being made thin.

According to an embodiment of the present invention, in order to solve the above problem, a groove is formed in the frame of the window substrate where the decoration layer is formed to remove the step difference generated when the decoration layer is formed and to reduce the thickness of the touch screen panel provided on the window substrate.

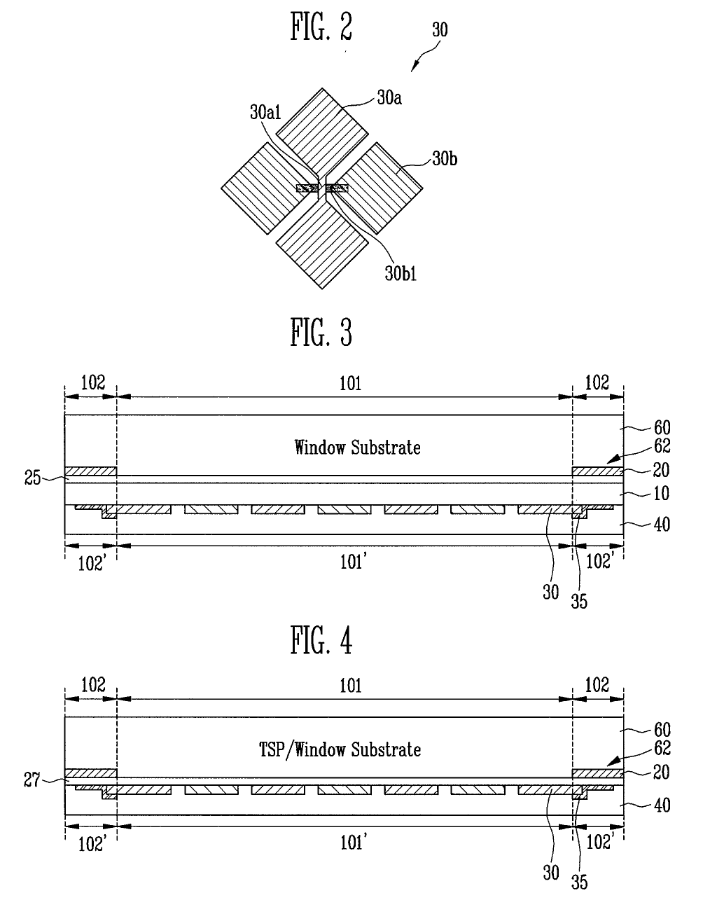

The above structure according to the embodiment of the present invention will be described in more detail with reference to FIGS. 3 and 4.

FIG. 3 is a cross sectional view illustrating a touch screen panel according to an embodiment of the present invention.

Referring to FIG. 3, the touch screen panel according to an embodiment of the present invention includes a transmitting region 101, a window substrate 60 in which a groove 62 is formed in a frame 102 provided outside the transmitting region 101, a decoration layer 20 formed in the frame 102 realized as the groove 62, a transparent adhesive layer 25 formed on one surface of the window substrate 60 including the top surface of the decoration layer 20, a touch inactive region 102′ corresponding to the frame 102, a transparent substrate 10 positioned at the touch inactive region 102′ and including a touch active region 101′ corresponding to the transmitting region 101, a plurality of conductive sensing patterns 30 formed on the touch active region 101′ of the transparent substrate 10, position detecting lines 35 formed on the touch inactive region 102′, and a protective layer 40 formed on the transparent substrate 10 including the top surfaces of the conductive sensing patterns 30 and the position detecting lines 35.

The window substrate 60 is attached to the outermost surface in order to improve the strength of the apparatus of the touch screen panel as described above and may be formed of a transparent substrate such as glass, polyethylene terephthalate (PET), or acryl. Here, being transparent refers to being transparent so as to have high transmittance (e.g., semi-transparent) as well as being 100% transparent.

According to the embodiment of the present invention, the groove 62 is formed in the frame 102 of the window substrate 60, that is, in the region that overlaps the touch inactive region 102′ of the touch screen panel.

Here, the groove 62 may be formed using CNC grinding, chemical etching, or physical grinding, or may be formed in a high temperature heated window substrate from the beginning using a molding method.

As shown in the drawing, the decoration layer 20 is formed at the frame 102 of the window substrate 60 realized by the groove 62 to fill the groove 62.

That is, the decoration layer 20 is formed to fill the previously provided groove 62 by coating, printing, or ink jet printing methods.

Therefore, although the decoration layer 20 is formed on the window substrate 60 a step difference caused by the thickness of the decoration layer 20 is not generated like in the conventional art.

When logos such as characters and figures are displayed in a part of the window substrate frame 102 where the decoration layer 20 is formed, in order to remove additional step difference generated when the logos are formed, a suitable shape (for example, a protrusion or a recess) for compensating for the step difference may be further formed in the groove 62.

As a result, although the decoration layer 20 according to an embodiment of the present invention is formed on the window substrate 60, since the step difference is not generated, the thickness of the transparent adhesive layer 25 formed on one surface of the window substrate 60 including the top of the decoration layer 20 to be adhered to the touch screen panel may be minimized or reduced.

Here, the transparent adhesive layer 25 may be formed of an optically clear adhesive (OCA) or a super viewing resin (SVR).

As illustrated in the drawing, the transparent substrate 10 on which the conductive sensing patterns 30 and the position detecting lines 35 are formed is attached to the external surface of the transparent adhesive layer 25.

The conductive sensing patterns 30 are formed at the touch active region 101′ on the transparent substrate using a transparent electrode material and are coupled to the position detecting lines 35 formed at the touch inactive region 102′ in units of row lines or column lines.

That is, the position detecting lines 35 are formed at the touch inactive region 102′ on the transparent substrate to be coupled to the sensing patterns 30 in units of row lines or column lines.

Since the structure of the sensing patterns 30 is described in detail with reference to FIGS. 1 and 2, for convenience sake, in FIG. 3, coupling lines for coupling the conductive sensing patterns 30 in units of row lines or column lines and an insulating layer interposed between the coupling lines will be omitted.

The protective layer 40 is formed using a transparent insulating material and may be entirely formed on the transparent substrate 10 including the tops of the conductive sensing cells 30 and the position detecting lines 35.

According to the embodiment illustrated in FIG. 3, the thickness of the transparent adhesive layer 25 is reduced or minimized to reduce the entire thickness of the touch screen panel.

However, since the window substrate 60 and the transparent adhesive layer 25 are provided separately from the touch screen panel, the thickness of the touch screen panel increases.

In the embodiment illustrated in FIG. 4, the transparent substrate 10 in which the sensing patterns 30 and the position detecting lines 35 are formed is replaced by the window substrate 60 to remove the transparent substrate 10 and the transparent adhesive layer 25. Therefore, the thickness of the touch screen panel is reduced or minimized.

FIG. 4 is a cross sectional view illustrating a touch screen panel according to another embodiment of the present invention.

The same elements as those of the embodiment of FIG. 3 are denoted by the same reference numerals and detailed description thereof will be omitted.

Referring to FIG. 4, a touch screen panel according to an embodiment of the present invention includes the transmitting region 101, the window substrate 60 in which the groove 62 is formed in the frame 102 provided outside of the transmitting region 101, the decoration layer 20 formed in the frame 102 realized as the groove 62, a buffer layer 27 formed on one surface of the window substrate 60 including the top of the decoration layer 20, the conductive sensing patterns 30 and the position detecting lines 35 formed on the buffer layer 27, and the protective layer 40 formed on the tops of the conductive sensing patterns 30 and the position detecting lines 35.

Here, the conductive sensing patterns 30 are formed on a part of the buffer layer 27 that overlaps the transmitting region 101. The transmitting region 101 corresponds to the touch active region 101′. The position detecting lines 35 are formed on a part of the buffer layer 27 that overlaps the frame 102. The frame 102 corresponds to the touch inactive region 102′.

In the embodiment of FIG. 4, patterns for realizing the touch screen panel are formed on the window substrate 60 to realize a window integrated touch screen panel in which the transparent substrate 10 and the window substrate 60 are integrated. Therefore, the thickness of the display device that adopts the touch screen panel is reduced.

In addition, in the embodiment of FIG. 4, unlike in the embodiment of FIG. 3, instead of using the transparent adhesive layer 25 for adhering the window substrate 60 to the transparent substrate 10, the buffer layer 27 is formed and the sensing patterns 30 and the position detecting lines 35 for realizing the touch screen panel are formed on the buffer layer 27.

In this case, as illustrated in the drawing, the groove 62 is formed in the frame 102 of the window substrate 60, that is, the region that overlaps the touch inactive region 102′ of the touch screen panel and the decoration layer 20 is formed to fill the groove 62. Accordingly, although the decoration layer 20 is formed on the window substrate 60, a step difference is not generated so that the thickness of the buffer layer 27 formed on the decoration layer 20 may be minimized or reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a window substrate comprising a transmitting region, a frame outside of the transmitting region, and a groove at the frame;
a decoration layer at the groove;
a transparent adhesive layer on a surface of the window substrate and a top of the decoration layer;
a transparent substrate adhered to the window substrate by the transparent adhesive layer, the transparent substrate comprising a touch inactive region corresponding to the frame and a touch active region corresponding to the transmitting region; and
a plurality of conductive sensing patterns on the touch active region of the transparent substrate and position detecting lines on the touch inactive region.

2. The touch screen panel as claimed in claim 1, further comprising a protective layer on the transparent substrate and top of the conductive sensing patterns and the position detecting lines.

3. The touch screen panel as claimed in claim 1, wherein the sensing patterns comprise:
first sensing cells coupled to one another by column lines in a first direction;
first coupling lines for coupling adjacent ones of the first sensing cells;
second sensing cells coupled to one another by row lines in a second direction; and
second coupling lines for coupling adjacent ones of the second sensing cells.

4. The touch screen panel as claimed in claim 3, wherein insulating layers are interposed at crossing regions of the first coupling lines and the second coupling lines.

5. The touch screen panel as claimed in claim 3, wherein the first sensing cells and the second sensing cells comprise a transparent conductive material.

6. A touch screen panel comprising:
a window substrate comprising a transmitting region, a frame outside the transmitting region, and a groove at the frame;
a decoration layer at the groove;
a buffer layer on a surface of the window substrate and a top of the decoration layer; and
conductive sensing patterns on a part of the buffer layer that overlaps the transmitting region and position detecting lines on a part of the buffer layer that overlaps the frame.

7. The touch screen panel as claimed in claim 6, further comprising a protective layer on the buffer layer and tops of the conductive sensing patterns and the position detecting lines.

8. The touch screen panel as claimed in claim 6, wherein the sensing patterns comprise:
first sensing cells coupled to one another by column lines in a first direction;
first coupling lines for coupling adjacent ones of the first sensing cells;
second sensing cells coupled to one another by row lines in a second direction; and
second coupling lines for coupling adjacent ones of the second sensing cells.

9. The touch screen panel as claimed in claim 8, wherein insulating layers are interposed at crossing regions of the first coupling lines and the second coupling lines.

10. The touch screen panel as claimed in claim 8, wherein the first sensing cells and the second sensing cells comprise a transparent conductive material.
